(19) United States
(12) Patent Application Publication
(10) Pub. No.: US 2017/0077991 A1
(43) Pub. Date: Mar. 16, 2017

(54) DEVICE FOR THE TRANSMISSION OF SIGNALS

(71) Applicant: Dr. Johannes Heidenhain GmbH, Traunreut (DE)

(72) Inventor: Daniel Schenzinger, Palling-Freutsmoos (DE)

(21) Appl. No.: 15/123,656

(22) PCT Filed: Dec. 9, 2014
(86) PCT No.: PCT/EP2014/077017

§ 371 Date: Sep. 5, 2016

(30) Foreign Application Priority Data
Mar. 6, 2014 (DE) 10 2014 204 155.4

(51) Int. Cl. H04B 3/56; H04L 25/02

(52) U.S. Cl. CPC H04B 3/56; H04L 25/0272; H04B 2203/547

(57) ABSTRACT

A device for transmitting power supply signals and data signals between a position-measuring device and subsequent electronics includes a four-to-two wire converter having two power supply terminals and two data transmission terminals on the position-measuring device side. The terminals of the four-to-two wire converter are connectable to corresponding terminals of the position-measuring device. The four-to-two wire converter is configured to extract, from the mixed signal received from the subsequent electronics, the power supply signals and the data signals that are received by the four-to-two wire converter from the subsequent electronics. The four-to-two wire converter is configured to output the power supply signals and the data signals that are received by the four-to-two wire converter via the power supply terminals and the data transmission terminals to the position-measuring device, and to introduce, into the mixed signal, data signals that are transmitted from the position-measuring device to the subsequent electronics.

### CROSS-REFERENCE TO PRIOR APPLICATIONS

This application is a U.S. National Stage Application under 35 U.S.C. §371 of International Application No. PCT/EP2014/077017 filed on Dec. 9, 2014, and claims benefit to German Patent Application No. DE 10 2014 204 155.4 filed on Mar. 6, 2014. The International Application was published in German on Sep. 11, 2015 as WO 2015/131967 A1 under PCT Article 21(2).

### FIELD

The present invention relates to a device for transmitting power supply signals and data signals between a position-measuring device and subsequent electronics. A device according to the present invention enables signals transmission via a single pair.

### BACKGROUND

Position-measuring devices are widespread in automation technology. They are used for measuring lengths or angles which are needed by subsequent electronics, for example, as actual values for position control loops to enable accurate positioning of components of a machine.

Such position-measuring devices are frequently used in machine tools where position values are needed, inter alia, to accurately maneuver the tool spindle and thereby enable automated precision machining of the workpiece. In this case, the subsequent electronics is referred to as numerical controller (NC).

Also known are position-measuring devices which generate velocity or acceleration values in addition to, or instead of, position values (lengths or angles). This means that the term “position-measuring device” as used herein is not only understood to mean a measuring device used to generate position measurement values or changes of position measurement values per se, but to include also measuring devices which are used for measuring the time dependence of position values, in particular in the form of speed or acceleration values.

The position-measuring device may also be what is known as a touch probe, which has a deflectable stylus capable of sensing (by touch) the spatial boundaries of an object, even in a time-dependent manner.

Data transmission between the position-measuring devices and the subsequent electronics is preferably performed digitally via serial interfaces. A position-measuring device having such a serial interface is described, for example, in EP 0 660 209 A1. Here, two line pairs are needed for the communication between the position-measuring device and the subsequent electronics; one for bidirectional transmission of commands and data, and another one for transmitting a clock signal to synchronize the transmission. In order to achieve higher interference immunity, it is preferred to transmit the signals differentially, for example, in accordance with the RS-485 standard commonly used in automation technology, and therefore line pairs are used for signal transmission. Since, in addition to the two line pairs needed for communication, at least two further lines are needed for supplying power to the position-measuring device, three line pairs are required for operating this position-measuring device via the subsequent electronics.

Since the electrical lines used here represent a significant cost factor, especially in machines and installations where the position-measuring devices and the subsequent electronics are spaced far apart, there is a demand to reduce the number of lines required for operating the position-measuring devices via subsequent electronics. DE 10 2008 027 902 A1, for example, introduces an interface that does not need a separate clock line pair. The number of required lines is thereby reduced to two line pairs.

Furthermore, there are efforts to reduce the number of required lines to even only one line pair. To this end, it is necessary to generate a mixed signal capable of transmitting both the power supply signals and the data signals. However, since position-measuring devices intended and suitable for industrial use are required to be compact in design and suitable for maximum permissible device temperatures of 150° C. and above, it is often problematic to integrate the electrical components required for generating and processing this mixed signal into the position-measuring devices.

### SUMMARY

In an embodiment, the present invention provides a device for transmitting power supply signals and data signals between a position-measuring device and subsequent electronics. The position-measuring device has two power supply terminals and two data transmission terminals for bidirectional, differential data transmission, and the power supply and data signals are transmitted over a main transmission path in the form of a mixed signal via a single line pair. The device includes a four-to-two wire converter which has two power supply terminals and two data transmission terminals on a side of the position-measuring device. The terminals of the four-to-two wire converter are connectable to corresponding terminals of the position-measuring device. The four-to-two wire converter is configured to extract, from the mixed signal received from the subsequent electronics, the power supply signals and the data signals that are received by the four-to-two wire converter from the subsequent electronics. The four-to-two wire converter is configured to output the power supply signals and the data signals that are received by the four-to-two wire converter via the power supply terminals and the data transmission terminals to the position-measuring device, and to introduce, into the mixed signal, data signals that are transmitted from the position-measuring device to the subsequent electronics.

### BRIEF DESCRIPTION OF THE DRAWINGS

The present invention will be described in even greater detail below based on the exemplary figures. The invention is not limited to the exemplary embodiments. All features described and/or illustrated herein can be used alone or combined in different combinations in embodiments of the invention. The features and advantages of various embodiments of the present invention will become apparent by reading the following detailed description with reference to the attached drawings which illustrate the following:

FIG. 1 illustrates the basic design of a first embodiment of a device according to the present invention;

FIG. 2 illustrates the basic design of another embodiment of a device according to the present invention;

FIG. 2A illustrates the basic design of a further embodiment of a device according to the present invention;

FIG. 2B illustrates the basic design of another embodiment of a device according to the present invention;

FIG. 2C illustrates the basic design of a further another embodiment of a device according to the present invention;

FIG. 3A illustrates the basic design of another embodiment of a device according to the present invention;

FIG. 3B illustrates the basic design of yet another embodiment of a device according to the present invention;

FIG. 4 shows a block diagram of a device according to an embodiment of the present invention;

FIG. 5 shows a circuit diagram of a preferred embodiment of a device according to the present invention.

### DETAILED DESCRIPTION

In an embodiment, the present invention provides a device which enables signal transmission via a reduced number of lines, while satisfying the aforementioned boundary conditions.

In an embodiment, the present invention provides a device for transmitting power supply signals and data signals between a position-measuring device and subsequent electronics, where the position-measuring device has two power supply terminals and two data transmission terminals for bidirectional, differential data transmission, and the power supply and data signals are transmitted over a main transmission path in the form of a mixed signal via a single line pair, and where the device includes a four-to-two wire converter which has two power supply terminals and two data transmission terminals on the measuring device side, these terminals being connectable to corresponding terminals of the position-measuring device, and which receives the mixed signal from the subsequent electronics and is configured to extract, from the mixed signal, the power supply signals and the data signals that are received by the four-to-two wire converter from the subsequent electronics, and to output these signals via the power supply terminals and the data transmission terminals to the position-measuring device, and to introduce, into the mixed signal, data signals that are transmitted from the position-measuring device to the subsequent electronics.

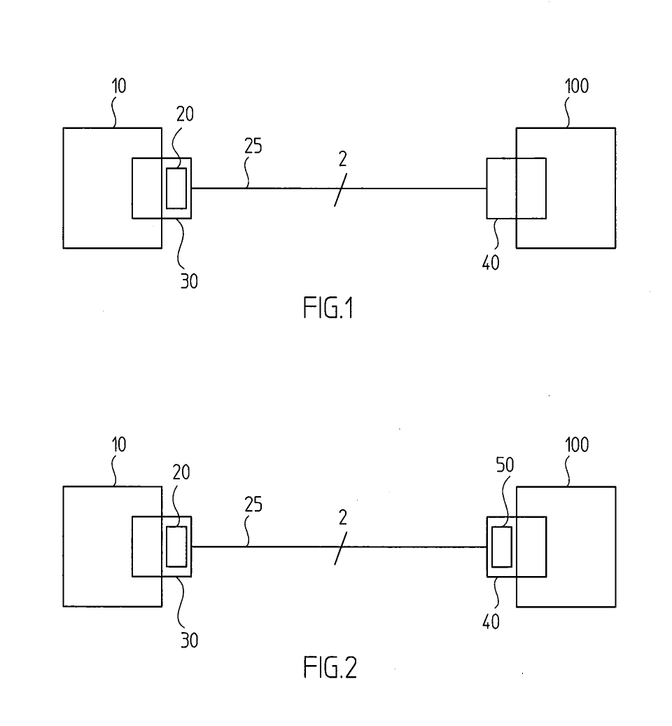

FIG. 1 shows the basic design of a first embodiment of an inventive device for transmitting power supply signals and data signals between a position-measuring device 10 and subsequent electronics 100. Subsequent electronics 100 may be any controller used in automation technology, such as, for example, a numerical machine tool controller (NC).

Since position-measuring devices are typically powered from the subsequent electronics, the power supply signals are unidirectionally transmitted from subsequent electronics 100 to position-measuring device 10. In contrast, data signals are transmitted bidirectionally. For instance, subsequent electronics 100 transmits, for example, commands and possibly data (e.g., configuration data) to position-measuring device 10, while position-measuring device 10 executes received commands and possibly transmits requested data, in particular measurement values (e.g., position values, velocity values, acceleration values, . . . ), to subsequent electronics 100.

Position-measuring device 10 has two power supply terminals and two data transmission terminals for bidirectional, differential data transmission, for example according to the known RS-485 standard. Such an interface is known, for example, from DE 10 2008 027 902 A1 and will hereinafter be referred to as “four-wire interface.” The inventive device includes a four-to-two-wire converter 20 which also has two power supply terminals and two data transmission terminals on the measuring device side, these terminals being connectable to corresponding terminals of the four-wire interface of position-measuring device 10. In this exemplary embodiment, the connection of the power supply terminals and the data transmission terminals is via a first connector 30 which is connectable to a corresponding counterpart of position-measuring device 10. Here, four-to-two-wire converter 20 is disposed in the housing of first connector 30.

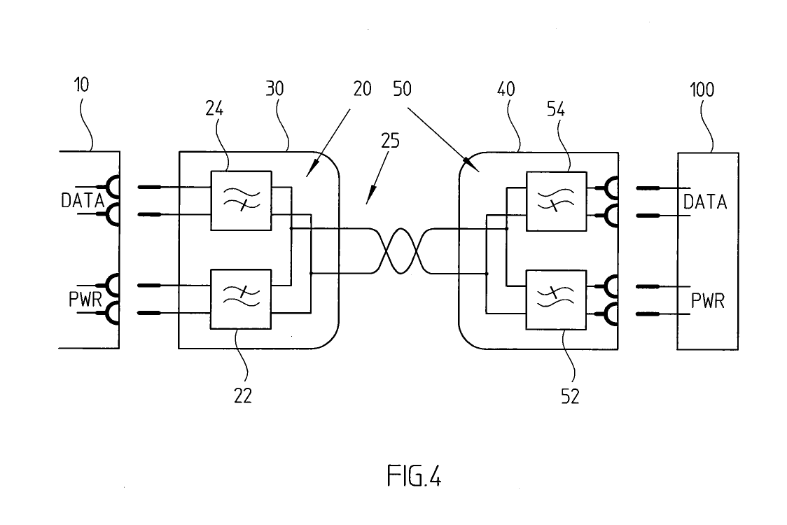

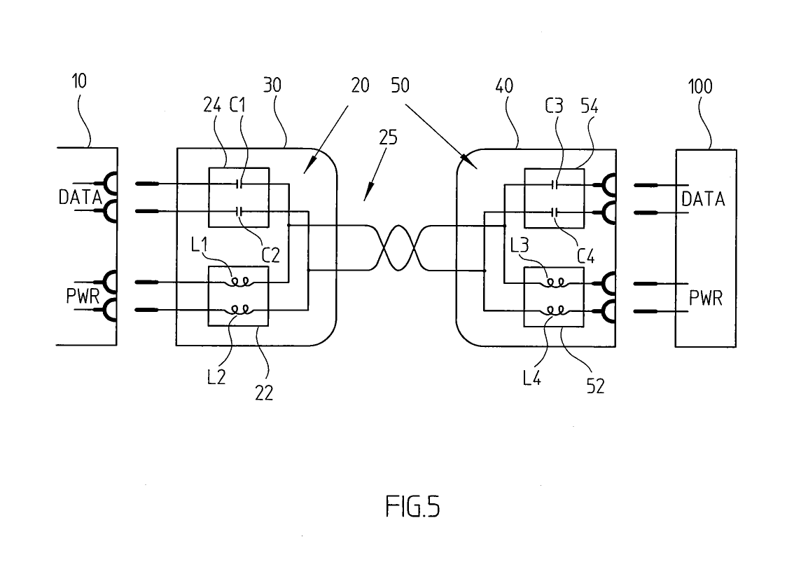

Four-to-two-wire converter 20 is suitably adapted to extract, from a mixed signal received from subsequent electronics 100 via a single line pair 25, the power supply signals as well as the data signals that are to be transmitted from subsequent electronics 100 to position-measuring device 10, and to feed these signals via the corresponding terminals to position-measuring device 10. Further, four-to-two-wire converter 20 is suitably adapted to introduce, into the mixed signal, data signals that are to be transmitted from position-measuring device 10 to subsequent electronics 100. The mixed signal is a suitable signal capable of transmitting power supply signals and (bidirectional) data signals via line pair 25. The mixed signal may be, for example, a power supply signal having a data signal modulated thereupon. In a preferred embodiment, as will be illustrated below with reference to FIGS. 4 and 5, the introduction and extraction of data signals may be accomplished simply by coupling them in and out using a high-pass filter, while a low-pass filter may be provided for separating the power supply signals from the data signals.

Alternatively, the mixed signal may be generated by transmitting power supply signals and data signals via line pair 25 using a time-division multiplexing technique.

The two wires of line pair 25 are preferably twisted together. In addition, line pair 25 may be surrounded by a shield (e.g., wire mesh or metal foil) to protect the mixed signal from interference caused by electromagnetic fields in the environment of line pair 25. In order to provide protection from mechanical damage, line pair 25 and the optional shield are advantageously surrounded by a plastic sheath. Such cables and the connection technology thereof are per se known to those skilled in the art.

At subsequent electronics 100, a second connector 40 may be provided which is connectable to a corresponding counterpart of subsequent electronics 100. In this exemplary embodiment, subsequent electronics 100 has a two-wire interface to which line pair 25, via which the mixed signal is transmitted, can be directly connected. Thus, second connector 40 needs only one contact pair for the connection.

The length of line pair 25 constitutes a main transmission path over which the power supply signals and the data signals are transmitted as a mixed signal.

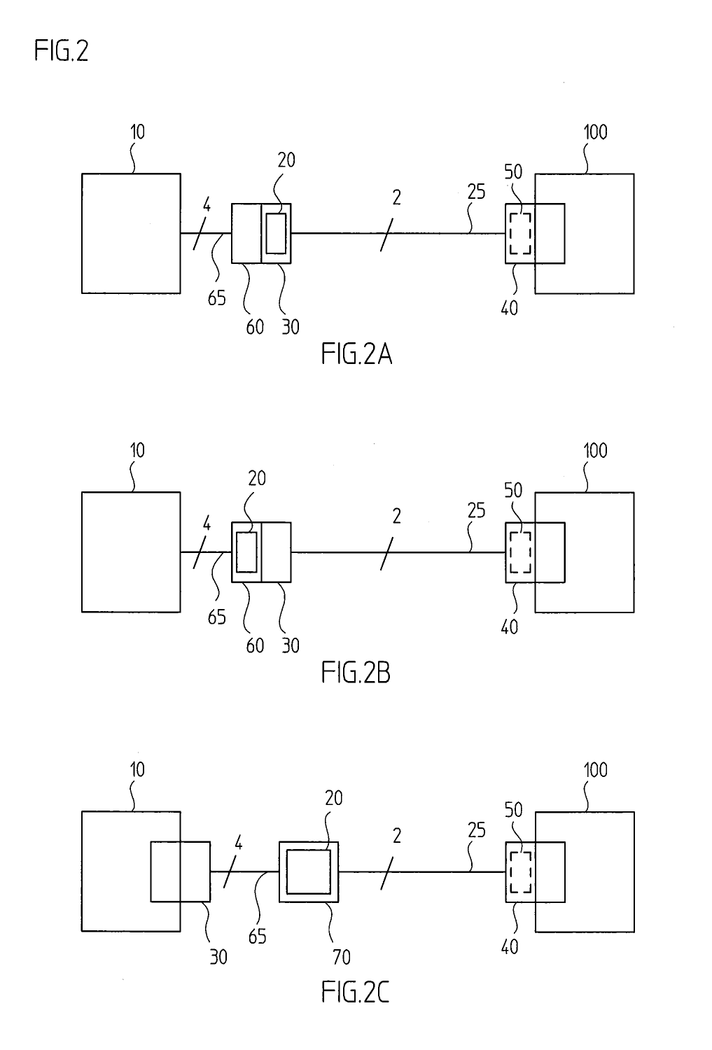

FIG. 2 illustrates the basic design of another embodiment of an inventive device for transmitting power supply signals and data signals between a position-measuring device 10 and subsequent electronics 100. In addition to the embodiment illustrated with reference to FIG. 1, here, a two-to-four wire converter 50 disposed at subsequent electronics 100 as a counterpart to the four-to-two-wire converter. This two-to-four wire converter has two power supply terminals and two data transmission terminals, which are connectable to corresponding terminals of subsequent electronics 100, as well as two terminals for connection to line pair 25, via which the mixed signal is transmitted.

Two-to-four wire converter 50 is suitably adapted to introduce, into the mixed signal, the power supply signals and the data signals that are received by two-to-four wire converter 50 from subsequent electronics 100, and to output these signals via line pair 25 to position-measuring device 10, as well as to extract, from the mixed signal, the data signals that are received by two-to-four wire converter 50 from position-measuring device 10, and to output these signals to subsequent electronics 100.

Thus, this embodiment is suitable for connecting subsequent electronics 100 having a four-wire interface (two power supply terminals and two data transmission terminals) to a corresponding four-wire interface of a position-measuring device 10; the signals being transmitted over the main transmission path in the form of a mixed signal via a single line pair 25. Thus, the device of to the present invention can replace a conventional connecting cable which would require two line pairs over the entire transmission path for signal transmission.

In this example, too, the length of line pair 25 corresponds to the main transmission path.

FIG. 2A illustrates the basic design of a further embodiment of a device according to the present invention. In comparison to the previous embodiments, the connection of the device, particularly of four-to-two-wire converter 20, to the four-wire interface of position-measuring device 10 is here via a connection cable 65 having two line pairs. Thus, position-measuring device 10 and four-to-two wire converter 20 can be disposed spatially apart from one another and are thereby optimally thermally decoupled from each other. This means that the components forming the four-to-two wire converter may optionally be designed for a lower operating temperature than, for example, position-measuring device 10 or the components thereof. In this connection, it is particularly advantageous if connection cable 65 is as short as possible compared to the main transmission path (the length of the cable containing line pair 25).

Again, first connector 30 may be provided to make the connection. Here, first connector 30 is connectable via a third connector 60 to connection cable 65. The four-to-two-wire converter is disposed in the housing of first connector 30, and thus, two contact pairs are required in each of the connectors 30, 60 to make the connection.

While, again, a connector may be provided on the housing of position-measuring device 10 to connect connection cable 65 to the power supply and data transmission terminals of position-measuring device 10, the connection is advantageously made inside the housing, for example, via miniature connectors, soldered connections or clamped connections, because such connections require very little space. Thus, position-measuring device 10 can be made very small and requires little space for installation due to the absence of a connector on the housing of position-measuring device 10.

The power supply and data signals are still transmitted over the main transmission path in the form of a mixed signal via a single line pair 25. In this exemplary embodiment, too, a second connector 40 may be provided at subsequent electronics 100. If the interface of subsequent electronics 100 is a four-wire interface, a two-to-four wire converter 50 is disposed in the housing of second conductor 40.

Thus, besides the advantages already mentioned, this embodiment provides two additional advantages. First of all, it enables a compact design of position-measuring device 10. Secondly, position-measuring device 10 and four-to-two-wire converter 20 are now optimally thermally decoupled from each other.

FIG. 2B shows, as another embodiment, a variant of the embodiment illustrated in FIG. 2A. Here, four-to-two-wire converter 20 is disposed in the housing of third connector 60. In this way, the number of contacts can be reduced to one contact pair in each of connectors 30, 60.

FIG. 2C illustrates the basic design of a further embodiment of an inventive device, which is based on the variants discussed hereinbefore with reference to FIGS. 2A and 2B. Here, four-to-two-wire converter 20 is disposed in a module 70, and the two line pairs of connection cable 65 as well as the one line pair 25 of the main transmission path are connected directly to the corresponding terminals of four-to-two-wire converter 20, for example via soldered connections. It is particularly advantageous if module 70 is hermetically sealed and possibly filled with a potting compound.

The connection of the device to position-measuring device 10 is, for example, via first connector 30 and a corresponding counterpart provided on the housing of position-measuring device 10.

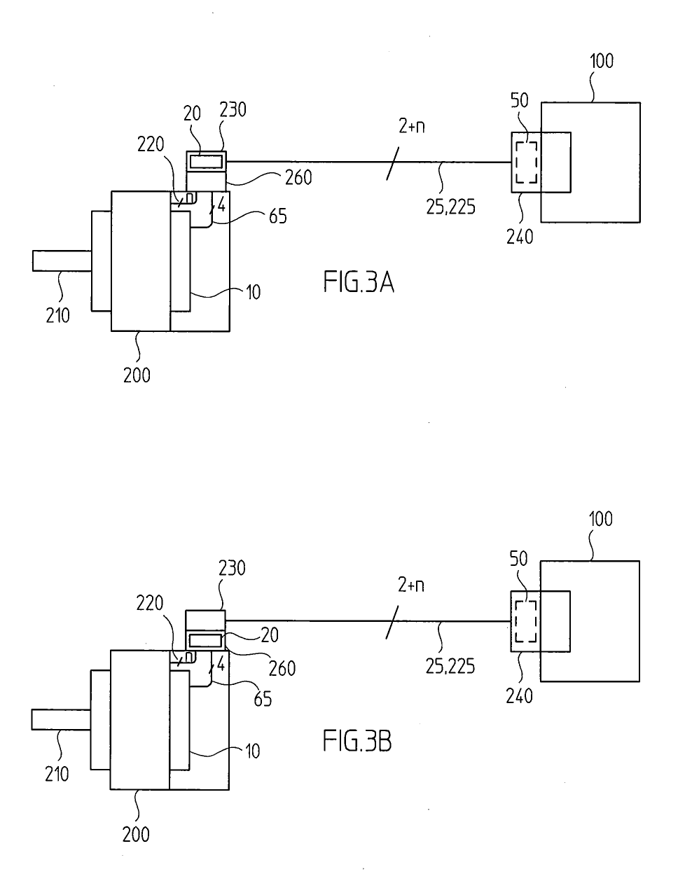

FIG. 3A illustrates the basic design of another embodiment of a device according to the present invention. In this example, position-measuring device 10 is an integrated rotary encoder suitable for measuring the position of the shaft 210 of an electric motor 200.

The device according to the present invention corresponds largely to the device described with reference to FIG. 2A; i.e., the transmission of power supply signals and data signals between position-measuring device 10 and subsequent electronics 100 is via a connection cable 65, a third connector 260, a first connector 230, a line pair 25 and a second connector 240. A four-to-two-wire converter 20 is disposed in first connector 230, and a two-to-four wire 50 converter 50 is optionally provided in the second connector.

In a departure from the device described with reference to FIG. 2A, line pair 25 is here disposed within a motor cable 225. Besides line pair 25, motor cable 225 has a number n of additional lines which are used for signal transmission between subsequent electronics 100 and electrical motor 200. The additional lines may be provided for controlling power to electric motor 200 as well as for transmitting braking signals or sensor signals (e.g., from a temperature sensor).

For the sake of completeness, it should be noted that connectors 230, 240, 260 are equipped with contacts that meet the requirements with regard to power and signal quality of the signals to be transmitted via the additional lines.

FIG. 3B shows the basic design of a variant of the embodiment discussed with reference to FIG. 3A. In this example, the four-to-two-wire converter is associated with third connector 260; i.e., within the housing of third connector 260 or within the motor housing in close proximity to third connector 260. This again reduces the required number of contacts in connectors 230, 260. Advantageously, a ready-made standard cable assembly can here be used for connecting electric motor 200, the ready-made standard cable assembly including first connector 230, motor cable 225 and second connector 240 and containing the number n of lines as well as line pair 25.

FIG. 4 shows a block diagram of a device according to an embodiment of the present invention where a four-to-two-wire converter 20 is disposed in first connector 30 and a two-to-four wire converter 50 is disposed in second connector 40. Connectors 30, 40 are connectable to their corresponding counterparts in position-measuring device 10 and subsequent electronics 100, respectively.

In order for data signals to be to be introduced into (coupled into) and extracted (coupled out) from the mixed signal that is transmitted via line pair 25, high-pass filters 24, 54 are disposed both in four-to-two-wire converter 20 and two-to-four wire converter 50. These high-pass filters are connected, on the one hand, to the data transmission terminals DATA of position-measuring device 10 and subsequent electronics 100, respectively, and, on the other hand, to line pair 25. High-pass filters 24, 54 pass the high-frequency data signals and block low-frequency signals or DC signals (power supply signals).

In order to separate the power supply signals from the data signals, low-pass filters 22, 52 are disposed in four-to-two-wire converter 20 and in two-to-four wire converter 50. These low-pass filters are in turn connected, on the one hand, to the respective power supply terminals PWR of position-measuring device 10 and subsequent electronics 100, and, on the other hand, also to line pair 25.

Advantageously, four-to-two-wire converter 20 and two-to-four wire converter 50 are identical in configuration.

This embodiment can be used in particular if the data signals are transmitted without any DC component. This is the case, for example, when a DC component-free encoding scheme (e.g., Manchester or 8b10b encoding) is used for the data transmission.

FIG. 5 shows a preferred embodiment of an inventive device that is based on the embodiment described with reference to FIG. 4. Of particular advantage here is that only passive components; i.e., components which themselves do not need to be powered, are used to implement high-pass filters 24, 54 and low-pass filters 22, 52 in four-to-two-wire converter 20 and two-to-four wire converter 50.

Specifically, high-pass filters 24 and 54 each include two capacitors C1, C2, respectively C3, C4, and low-pass filters 22 and 52 each include two coils L1, L2, respectively L3, L4. These components are both inexpensive and rugged, so that a high degree of reliability is achieved at little expense.

By way of example, but not by way of limitation, for a data transfer frequency of 25 MHz and a supply voltage of 12 V, coils L1-L4 may have a value of 10 pH, and capacitors C1-C4 may have a value of 220 nF.

Besides coils L1-L4 and capacitors C1-C4, four-to-two-wire converter 20 and two-to-four wire converter 50 may include additional components, such as termination resistors, etc.

The present invention is not limited to the exemplary embodiments described herein. Rather, one skilled in the art can devise additional variants without departing from the subject matter of the present invention.

While the invention has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below. Additionally, statements made herein characterizing the invention refer to an embodiment of the invention and not necessarily all embodiments.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

1. A device for transmitting power supply signals and data signals between a position-measuring device and subsequent electronics, wherein the position-measuring device has two power supply terminals and two data transmission terminals for bidirectional, differential data transmission, and the power supply and data signals are transmitted over a main transmission path in the form of a mixed signal via a single line pair, the device comprising:
a four-to-two wire converter which has two power supply terminals and two data transmission terminals on a side of the position-measuring device, the terminals of the four-to-two wire converter being connectable to corresponding terminals of the position-measuring device, wherein the four-to-two wire converter is configured to extract, from the mixed signal received from the subsequent electronics, the power supply signals and the data signals that are received by the four-to-two wire converter from the subsequent electronics, and wherein the four-to-two wire converter is configured to output the power supply signals and the data signals that are received by the four-to-two wire converter via the power supply terminals and the data transmission terminals to the position-measuring device, and to introduce, into the mixed signal, data signals that are transmitted from the position-measuring device to the subsequent electronics.

2. The device as recited in claim 1, wherein the device is configured to be connected to the position-measuring device via a first connector which is connectable to a corresponding counterpart of the position-measuring device, and wherein the four-to-two-wire converter is disposed in a housing of the first connector.

3. The device as recited in claim 1, wherein the device is connected to the position-measuring device via a first connector and a third connector, which is a counterpart to the first connector, and via a connection cable two line pairs.

4. The device as recited in claim 3, wherein the first connector and the third connector have one contact pair for transmitting the mixed signal, and the four-to-two-wire converter is disposed in a housing of the third connector.

5. The device as recited in claim 3, wherein the first connector and the third connector have two contact pairs for transmitting the power supply signals and the data signals, and the four-to-two-wire converter is disposed in a housing of the first connector.

6. The device as recited in claim 1, wherein the line pair of the main transmission path is connectable to the subsequent electronics at corresponding terminals for transmitting the mixed signal.

7. The device as recited in claim 6, wherein the device is configured to be connected to the subsequent electronics via a second connector which is connectable to a corresponding counterpart of the subsequent electronics and wherein the second connector has one contact pair for transmitting the mixed signal.

8. The device as recited in claim 1, wherein the subsequent electronics has two power supply terminals and two data transmission terminals for bidirectional, differential data transmission, the device further comprising a two-to-four wire converter is disposed at the subsequent electronics, the two-to-four wire converter having two power supply terminals and two data transmission terminals which are connectable to corresponding terminals of the subsequent electronics, the two-to-four wire converter being configured to:
introduce, into the mixed signal received from the position-measuring device, the power supply signals and the data signals that are received by the two-to-four wire converter from the subsequent electronics;
output the power supply signals and the data signals that are received by the two-to-four wire converter from the subsequent electronics to the position-measuring device; and
extract, from the mixed signal, the data signals that are received by the two-to-four wire converter from the position-measuring device, and to output the data signals that are received by the two-to-four wire converter from the position-measuring device to the subsequent electronics.

9. The device as recited in claim 8, wherein the device is configured to be connected to the subsequent electronics via a second connector which has two contact pairs for transmitting the power supply signals and the data signals and is connectable to a corresponding counterpart of the subsequent electronics, and wherein the two-to-four-wire converter is disposed in a housing of the second connector.

10. The device as recited in claim 1, wherein the line pair is disposed within a motor cable.
